(19) United States
(12) Patent Application Publication
(10) Pub. No.: US 2023/0323955 A1
(43) Pub. Date: Oct. 12, 2023

(54) ANTI-STATIC GLOBE VALVE FOR HYPERBARIC OXYGEN AND METHOD FOR USING THE SAME

(71) Applicant: Jiangsu Evalve Co., Ltd., Yangzhong City (CN)

(72) Inventors: Shenghua SHEN, Yangzhong City (CN); Yufeng QIAN, Yangzhong City (CN); Qingrong ZHANG, Yangzhong City (CN)

(21) Appl. No.: 17/960,949

(22) Filed: Oct. 6, 2022

(30) Foreign Application Priority Data
Apr. 7, 2022 (CN) 202210361029.7

(51) Int. Cl. F16K 1/36; F16K 1/42; F16K 1/48; F16K 31/50; F16K 39/02

(52) U.S. Cl. CPC F16K 1/36; F16K 1/42; F16K 1/48; F16K 31/50; F16K 39/02

(57) ABSTRACT

An anti-static globe valve for hyperbaric oxygen and a method are provided, belong to the technical field of oxygen globe valves. The globe valve comprises a valve body, a valve disc, a valve seat and a valve stem. The valve seat is installed in the valve body, and the valve disc moves in an air channel of the valve body. When the valve disc is in contact with the valve seat, the valve disc is able to cut off the flowing of a medium in the air channel. When the valve disc is far away from the valve seat, the flowing of the medium in the air channel is allowed. An upper sleeve and a lower sleeve are further provided in the valve body, the upper sleeve is perpendicular to and in communication with the air channel, and the valve disc moves up and down in the upper sleeve.

### CROSS REFERENCE TO RELATED APPLICATION

The present application is a nonprovisional application which claims priority under 35 U.S.C. § 119 to Chinese Patent Application Serial Number 202210361029.7, filed Apr. 7, 2022, the disclosures of which are incorporated by reference herein.

### FIELD OF THE INVENTION

The present disclosure relates to the technical field of oxygen globe valves, and in particular relates to an anti-static globe valve for hyperbaric oxygen and a method for using the same.

### BACKGROUND

Hyperbaric oxygen media is flammable and explosive hazardous goods, and pipelines and valves for hyperbaric oxygen are the highest requirement level of equipment. The fundamental difference between oxygen and other media is that oxygen is an accelerant, and oxygen combustion does not require any other accelerant. In particular, hyperbaric oxygen cannot encounter any sparks, and even static electricity may detonate the hyperbaric oxygen. Therefore, anti-static performance is an important guarantee for the stable operation of the oxygen valve, and in design aspects, there are strict requirements for the size, shape and inner surface condition of flow channel, material selection, sealing surface design, anti-rotation structure of valve spool and valve stem, anti-dust measure for valve stem nut, the machining of parts of the valve and the like.

The traditional large-caliber hyperbaric oxygen globe valve employs a design of a structure of common globe valve and an outer bypass, and the flowing direction of the medium is mostly reversed, when the medium flows through, the valve disc and the valve stem may freely rotate by 360° due to the existence of a gap, easily causing friction. Two sealing pairs will also have rotational friction at the moment the valve disc is closed, which may generate electrostatic sparks and pose a greater safety hazard.

### SUMMARY OF THE INVENTION

An objective of the present embodiment is to provide an anti-static globe valve for hyperbaric oxygen and a method for using the same, so as to solve the problem that the traditional large-caliber hyperbaric oxygen globe valve is easy to generate electric sparks during operation and has a safety hazard.

To solve the technical problem above, the present disclosure provides an anti-static globe valve for hyperbaric oxygen. The globe valve includes a valve body, a valve disc, a valve seat, and a valve stem, wherein the valve body is provided with two air ports, one of the air ports is an air inlet, and the other of the air ports is an air outlet, and the two air ports are in communication with each other through an air channel.

The valve seat is installed in the valve body, the valve disc moves in the air channel of the valve body. The valve disc is configured to be able to cut off the flowing of a medium in the air channel when the valve disc is in contact with the valve seat, and to allow the flowing of the medium in the air channel when the valve disc is far away from the valve seat.

An upper sleeve and a lower sleeve are further provided in the valve body; the upper sleeve is perpendicular to and in communication with the air channel, and the valve disc moves up and down in the upper sleeve.

The lower sleeve is horizontally arranged between the upper sleeve and the valve seat, one end of the lower sleeve communicates with the air channel, and a sidewall of the lower sleeve communicates with the upper sleeve, such that the valve disc is able to enter into the lower sleeve when moving up and down along an inner wall of the upper sleeve; and when the valve disc enters into the lower sleeve to be in contact with the valve seat, the flowing of the medium in the air channel is able to be cut off

The valve stem is connected to the valve disc, and the valve disc is driven by the valve stem to move up and down.

In some embodiments, the globe valve further includes a bonnet, and the valve stem passes through and is slidingly connected to the bonnet.

In some embodiments, packing is filled between contact surfaces of the valve stem and the bonnet.

In some embodiments, the globe valve further comprises an actuating mechanism and a support, wherein the actuating mechanism is erected on the bonnet through the support; the actuating mechanism comprises a screw, a nut, and an actuator; the screw is meshed with the nut, and the nut is installed in the support by a bearing, and the actuating mechanism is configured to drive the nut to rotate so as to cause the screw to move linearly.

In some embodiments, the screw is connected to the valve stem (4) by a connecting clamp block, the connecting clamp block is fixedly connected to the valve stem and is rotationally connected to the screw.

In some embodiments, the valve stem and the valve disc are in threaded connection at conical contact surfaces, such that the valve stem and the valve disc are integrated as a whole.

In some embodiments, the section of the valve disc is U-shaped and may divide the upper sleeve into two spaces; and the valve disc has a height greater than a diameter of the lower sleeve.

In some embodiments, a lip-shaped seal ring is provided at the contact surfaces of the upper sleeve and the lower sleeve, and the lip-shaped seal ring is in contact with a sidewall of the valve disc.

In some embodiments, the valve disc is at least provided with one balance hole, and the balance hole is configured to communicate the two spaces separated by the upper sleeve with each other.

The present disclosure further provides a method for using the anti-static globe valve for hyperbaric oxygen, which includes:
(a) installing a valve seat, a lower sleeve and an upper sleeve in a valve body in sequence, and placing a lip-shaped seal ring between the lower sleeve and the upper sleeve;
(b) placing a valve disc fixedly connected with a valve stem into the valve body along an inner wall of the upper sleeve, and fixing a bonnet to the valve body after the bonnet is sleeved on the valve stem;
(c) installing an actuating mechanism on the bonnet by a support, and connecting the screw to the valve stem by a connecting clamp block;
(d) conveying an assembled anti-static globe valve for hyperbaric oxygen to a connecting position of a pipeline, and hermetically connecting two air ports of the valve body to the pipeline;
(e) rotating the actuating mechanism in a forward direction to cause the actuating mechanism to drive the nut to rotate and the screw rod meshed with the nut to move linearly, thereby enabling the valve stem to drive the valve disc to move upwards along an inner wall of the upper sleeve, causing an end of the lower sleeve to be opened, such that the anti-static globe valve for hyperbaric oxygen is opened to enable a medium to flow along an air channel of the valve body;
(f) during opening of the anti-static globe valve for hyperbaric oxygen, enabling the medium from one space of the upper sleeve to reach the other space of the upper sleeve through a balance hole to reduce the pressure difference between the two spaces, thus reducing an operation torque;
(g) rotating the actuating mechanism in a reverse direction to cause the valve stem to drive the valve disc to move downwards along the inner wall of the upper sleeve, causing the end of the lower sleeve to be gradually closed, such that the anti-static globe valve for hyperbaric oxygen is closed to cut off the flowing of the medium in the air channel of the valve body; and
(h) taking out the valve disc, the upper sleeve, the lower sleeve, the lip-shaped seal ring or the valve seat for replacement only by opening the bonnet when a component inside the anti-static globe valve for hyperbaric oxygen is damaged.

Compared with the prior art, the present disclosure has the beneficial effects that:
1. The valve disc and the valve stem of the anti-static globe valve for hyperbaric oxygen are of an integrated structure, such that the valve disc is free of rotational friction and always moves up and down during opening and closing. No friction phenomenon exists between two sealing surfaces at the moment the valve disc is closed, and thus static electricity is effectively avoided, and the safety of the globe valve is improved.
2. The anti-static globe valve for hyperbaric oxygen is provided with a balance hole on the valve disc and the pressure difference between an inlet and an outlet of the valve body is isolated by the seal ring. Due to the fact that the balance hole on the valve disc balances the upper pressure and the lower pressure of the valve disc, the requirement for lifting force is greatly lowered, and thus the operation torque is greatly reduced.
3. The valve seat, the valve disc, the upper sleeve and the lower sleeve of anti-static globe valve for hyperbaric oxygen each employ a replaceable structure, and can be taken out from a cavity of the valve body, such that the online maintenance of the valve body can be achieved without taking down the valve body from the pipeline.

### BRIEF DESCRIPTION OF THE DRAWINGS

FIG. 1 is a structure diagram of a first perspective of an anti-static globe valve for hyperbaric oxygen in accordance with the present disclosure;

FIG. 2 is a structure diagram of a second perspective of an anti-static globe valve for hyperbaric oxygen in accordance with the present disclosure;

FIG. 3 is a cross-sectional view of an anti-static globe valve for hyperbaric oxygen in accordance with the present disclosure;

FIG. 4 is a partial cross-sectional view of an anti-static globe valve for hyperbaric oxygen in accordance with the present disclosure in an open state;

FIG. 5 is a partial cross-sectional view of an anti-static globe valve for hyperbaric oxygen in accordance with the present disclosure in a closed state.

In the drawing: 1 valve body; 2 valve disc; 3 valve seat; 4 valve stem; 5 upper sleeve; 6 lower sleeve; 7 bonnet; 8 packing; 9 screw; 10 nut; 11 actuator; 12 support; 13 connecting clamp block; 14 lip-shaped seal ring; 15 balance hole.

### DETAILED DESCRIPTION OF THE EMBODIMENTS

The present disclosure is further described in detail below with reference to the accompanying drawings and specific embodiments. The advantages and features of the present disclosure will be more apparent from the following description and claims. It needs to be noted that the accompanying drawings are shown in a very simplified form and uses an imprecise ratio, only for the purpose of being convenient and clear to the auxiliary illustration of the various embodiments of the present disclosure.

In the description of the present disclosure, it needs to be understood that the orientation or positional relationship indicated by terms, such as “center”, “longitudinal”, “transverse”, “upper”, “lower”, “front ”, “back”, “left”, “right”, “vertical”, “horizontal”, “top”, “bottom”, “inside”, “outside”, is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. Furthermore, the terms “first” and “second” are used for descriptive purposes only and are not to be construed as indicating or implying relative importance or implying a number of the indicated technical features. As such, the features limited to “first” and “second” may explicitly or implicitly include one or more those features. In the description of the present disclosure, “a plurality of” means at least two, e.g., two, three, etc., unless expressly specified otherwise.

In the description of the present disclosure, unless expressly specified and limited otherwise, the terms “mounted,” “connected,” “connection,” “fixed,” and the like should be understood broadly, e.g., either fixed connection, detachable connection, or integral connection; either mechanical connection or electrical connection; either direct connection or indirect connection via an intermediate medium; either internal communication of two elements. The specific meanings of the above terms in the present disclosure may be understood by specific circumstances to those of ordinary skill in the art.

### Embodiment I

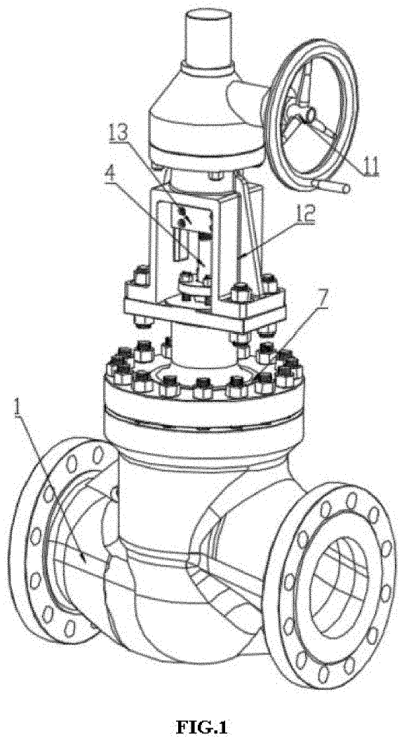

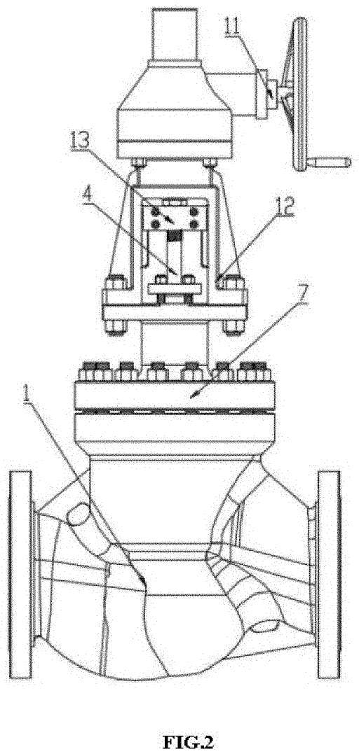

The present embodiment provides an anti-static globe valve for hyperbaric oxygen. Referring to FIG. 1 to FIG. 3, the globe valve comprises a valve body 1, a valve disc 2, a valve seat 3, and a valve stem 4. The valve body 1 is provided with two air ports, one of the air ports is an air inlet, and the other of the air ports is an air outlet, and the two air ports are in communication with each other through an air channel. The valve seat 3 is installed in the valve body 1, and the valve disc 2 moves in the air channel of the valve body 1. When the valve disc 2 is in contact with the valve seat 3, the valve disc 2 is able to cut off the flowing of a medium in the air channel. When the valve disc 2 is far away from the valve seat 3, the flowing of the medium in the air channel is allowed. An upper sleeve 5 and a lower sleeve 6 are further provided in the valve body 1. The upper sleeve 5 is perpendicular to and in communication with the air channel, and the valve disc 2 moves up and down in the upper sleeve 5. The lower sleeve 6 is horizontally arranged between the upper sleeve 5 and the valve seat 3, with one end communicating with the air channel, and a sidewall communicating with the upper sleeve 5, such that the valve disc 2 may enter into the lower sleeve 6 when moving up and down along an inner wall of the upper sleeve 5. When the valve disc 2 enters into the lower sleeve 6 to be in contact with the valve seat 3, the flowing of the medium in the air channel may be cut off. The valve stem 4 is connected to the valve disc 2, and the valve disc 2 is driven by the valve stem 4 to move up and down.

Specifically, the globe valve further comprises a bonnet 7, and the valve stem 4 passes through and is slidingly connected to the bonnet 7. Furthermore, the packing 8 is filled between the contact surfaces of the valve stem 4 and the bonnet 7. At least one layer of packing 8 is filled to play a role of sealing when the valve stem 4 moves back and forth in the bonnet 7.

In some embodiments, the uppermost layer of the packing 8 is further compacted by a packing pressing gland and a packing pressing plate to further improve the sealing effect.

Specifically, the globe valve further comprises an actuating mechanism and a support 12. The actuating mechanism is erected on the bonnet 7 by the support 12. The actuating mechanism comprises a screw 9, a nut 10, and an actuator 11. The screw 9 is meshed with the nut 10, the nut 10 is installed in the support 12 by a bearing. The actuator is configured to drive the nut 10 to rotate, thus making the screw 9 move linearly.

In some embodiments, the screw 9 is connected to the valve stem 4 by a connecting clamp block 13, the connecting clamp block 13 is fixedly connected to the valve stem 4 and rotationally connected to the screw 9, such that the screw 9 may drive the valve stem 4 to move up and down.

In some embodiments, the valve stem 4 and the valve disc 2 are in threaded connection at conical contact surfaces, such that the valve stem 4 and the valve disc 2 are integrated as a whole. It is guaranteed that the valve disc 2 is free of rotational friction in the process of opening and closing and always moves up and down. Therefore, it may be guarantee that no friction phenomenon exists between the valve disc 2 and two sealing surfaces of the valve seat 3 at the moment the valve disc is closed, and the anti-static performance is improved.

In some embodiments, a cross section of the valve disc 2 is U-shaped and may divide the upper sleeve 5 into two spaces. The valve disc 2 has a height greater than a diameter of the lower sleeve 6, such that the valve disc 2 may completely close the opening of the lower sleeve 6.

Specifically, a lip-shaped seal ring 14 is provided at the contact surfaces of the upper sleeve 5 and the lower sleeve 6, and the lip-shaped seal ring 14 is in contact with a sidewall of the valve disc 2, such that the lip-shaped seal ring 14 is a seal between the upper sleeve 5 and the lower sleeve 6, and is a seal between the upper sleeve 5 and the valve disc 2.

Specifically, the valve disc 2 is at least provided with one balance hole 15. The balance hole 15 is configured to communicate the two spaces separated by the upper sleeve 5 with each other. Due to the fact that the balance hole 15 on the valve disc 2 balances the upper pressure and the lower pressure of the valve disc 2, the requirement for the lifting force is greatly reduced, and an operation torque is reduced.

### Embodiment II

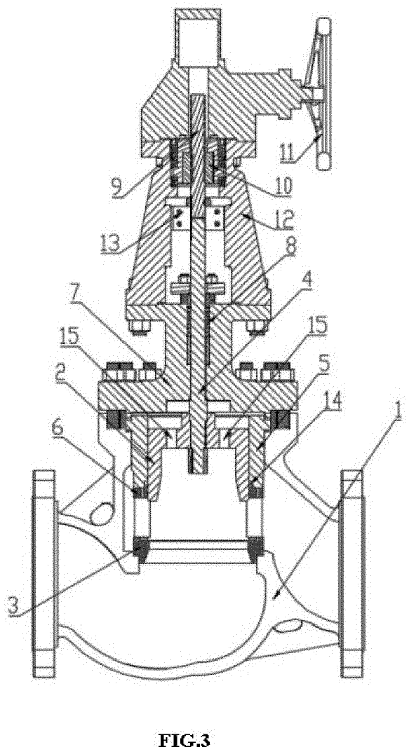

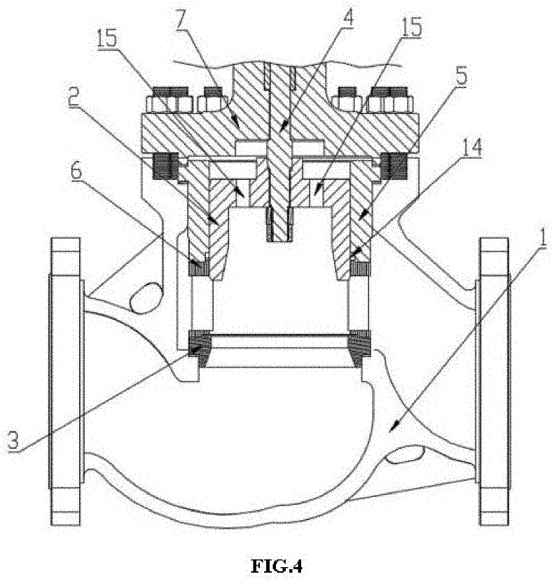

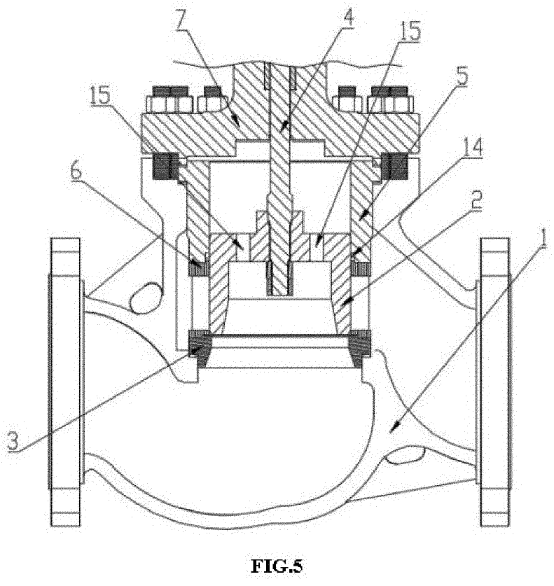

The present embodiment further provides a method for using an anti-static globe valve for hyperbaric oxygen. Referring to FIG. 3 to FIG. 5, the method comprises the following steps:
(a) installing a valve seat 3, a lower sleeve 6 and an upper sleeve 5 in a valve body 1 in sequence, and placing a lip-shaped seal ring 14 between the lower sleeve 6 and the upper sleeve 5;
(b) placing a valve disc 2 fixedly connected with a valve stem 4 into the valve body along an inner wall of the upper sleeve 5, and fixing a bonnet 7 to the valve body 1 after the bonnet is sleeved on the valve stem 4;
(c) installing an actuating mechanism on the bonnet 7 by a support 12, and connecting the screw 9 to the valve stem 4 by a connecting clamp block 13;
(d) conveying an assembled anti-static globe valve for hyperbaric oxygen to a connecting position of a pipeline, and hermetically connecting two air ports of the valve body 1 to the pipeline;
(e) rotating the actuating mechanism in a forward direction to cause the actuating mechanism to drive the nut 10 to rotate and the screw rod 9 meshed with the nut 10 to move linearly, thereby enabling the valve stem 4 to drive the valve disc 2 to move upwards along the inner wall of the upper sleeve 5, causing an end of the lower sleeve 6 to be opened such that the anti-static globe valve for hyperbaric oxygen is opened to enable a medium to flow along an air channel of the valve body 1;
(f) during opening of the valve, enabling the medium from one space of the upper sleeve to reach the other space of the upper sleeve 5 through a balance hole 15 to reduce the pressure difference between the two spaces, thus reducing an operation torque;
(g) rotating the actuating mechanism in a reverse direction to cause the valve stem 4 to drive the valve disc 2 to move downwards along the inner wall of the upper sleeve 5, causing the end of the lower sleeve 6 to be gradually closed, such that the anti-static glove valve for hyperbaric oxygen is closed to cut off the flowing of the medium in the air channel of the valve body 1;
(h) taking out the valve disc 2, the upper sleeve 5, the lower sleeve 6, the lip-shaped seal ring 14 or the valve seat 3 for replacement only by opening the bonnet 7 when a component inside the anti-static glove valve for hyperbaric oxygen is damaged. Such structure has the advantages that the online maintenance of the valve body 1 may be achieved without taking down the valve body from the pipeline.

The valve disc and the valve stem of the anti-static globe valve for hyperbaric oxygen are of an integrated structure, such that the valve disc is free of rotational friction and always moves up and down during opening and closing. No friction phenomenon exists between two sealing surfaces at the moment the valve disc is closed, and thus static electricity is effectively avoided, and the safety of the globe valve is improved. The valve disc is further provided with a balance hole on the valve disc and the pressure difference between an inlet and an outlet of the valve body is isolated by the seal ring. Due to the fact that the balance hole on the valve disc balances the upper pressure and the lower pressure of the valve disc, the requirement for lifting force is greatly lowered, and thus the operation torque is greatly reduced.

The above description is only a description of the preferred embodiments of the present disclosure, and does not limit the scope of the present disclosure. Any changes or modifications made by those skilled in the art according to the above valve disclosure shall fall within the scope of protection of the claims.

What is claimed is:

1. An anti-static globe valve for hyperbaric oxygen, comprising a valve body, a valve disc, a valve seat, and a valve stem, wherein the valve body is provided with two air ports being in communication with each other through an air channel, one of the air ports is an air inlet, and another of the air ports is an air outlet;
wherein the valve seat is installed in the valve body, the valve disc moves in the air channel of the valve body, the valve disc is configured to be able to cut off flowing of a medium in the air channel when the valve disc is in contact with the valve seat, and to allow the flowing of the medium in the air channel when the valve disc is far away from the valve seat;
an upper sleeve and a lower sleeve are further provided in the valve body; the upper sleeve is perpendicular to and in communication with the air channel, and the valve disc moves up and down in the upper sleeve;
the lower sleeve is horizontally arranged between the upper sleeve and the valve seat, one end of the lower sleeve communicates with the air channel, and a sidewall of the lower sleeve communicates with the upper sleeve such that the valve disc is able to enter into the lower sleeve when moving up and down along an inner wall of the upper sleeve; and when the valve disc enters into the lower sleeve to be in contact with the valve seat, the flowing of the medium in the air channel is able to be cut off; and
the valve stem is connected to the valve disc, and the valve disc is driven by the valve stem to move up and down.

2. The anti-static globe valve for hyperbaric oxygen according to claim 1, further comprising a bonnet, wherein the valve stem passes through and is slidingly connected to the bonnet.

3. The anti-static globe valve for hyperbaric oxygen according to claim 2, wherein packing is filled between contact surfaces of the valve stem and the bonnet.

4. The anti-static globe valve for hyperbaric oxygen according to claim 2, further comprising an actuating mechanism and a support , wherein the actuating mechanism is erected on the bonnet by the support; the actuating mechanism comprises a screw, a nut, and an actuator; the screw is meshed with the nut, and the nut is installed in the support by a bearing, and the actuator is configured to drive the nut to rotate so as to cause the screw to move linearly.

5. The anti-static globe valve for hyperbaric oxygen according to claim 4, wherein the screw is connected to the valve stem by a connecting clamp block, the connecting clamp block is fixedly connected to the valve stem and is rotationally connected to the screw.

6. The anti-static globe valve for hyperbaric oxygen according to claim 5, wherein the valve stem and the valve disc are in threaded connection at conical contact surfaces, such that the valve stem and the valve disc are integrated as a whole.

7. The anti-static globe valve for hyperbaric oxygen according to claim 1, wherein a cross section of the valve disc is U-shaped and is able to divide the upper sleeve into two spaces; and the valve disc has a height greater than a diameter of the lower sleeve.

8. The anti-static globe valve for hyperbaric oxygen according to claim 7, wherein a lip-shaped seal ring is provided at the contact surfaces of the upper sleeve and the lower sleeve, and the lip-shaped seal ring is in contact with a sidewall of the valve disc.

9. The anti-static globe valve for hyperbaric oxygen according to claim 7, wherein the valve disc is at least provided with one balance hole, and the balance hole is configured to communicate the two spaces separated by the upper sleeve with each other.

10. A method for using an anti-static globe valve for hyperbaric oxygen, which comprises a valve body, a valve disc, a valve seat, and a valve stem, wherein the valve body is provided with two air ports being in communication with each other through an air channel, one of the air ports is an air inlet, and another of the air ports is an air outlet;
wherein the valve seat is installed in the valve body, the valve disc moves in the air channel of the valve body, the valve disc is configured to be able to cut off flowing of a medium in the air channel when the valve disc is in contact with the valve seat, and to allow the flowing of the medium in the air channel when the valve disc is far away from the valve seat;
an upper sleeve and a lower sleeve are further provided in the valve body; the upper sleeve is perpendicular to and in communication with the air channel, and the valve disc moves up and down in the upper sleeve;
the lower sleeve is horizontally arranged between the upper sleeve and the valve seat, one end of the lower sleeve communicates with the air channel, and a sidewall of the lower sleeve communicates with the upper sleeve such that the valve disc is able to enter into the lower sleeve when moving up and down along an inner wall of the upper sleeve; and when the valve disc enters into the lower sleeve to be in contact with the valve seat, the flowing of the medium in the air channel is able to be cut off; and
the valve stem is connected to the valve disc, and the valve disc is driven by the valve stem to move up and down,
the method comprising:
(a) installing the valve seat, the lower sleeve and the upper sleeve in the valve body in sequence, and placing a lip-shaped seal ring between the lower sleeve and the upper sleeve;
(b) placing the valve disc fixedly connected with the valve stem into the valve body along an inner wall of the upper sleeve, and fixing a bonnet to the valve body after the bonnet is sleeved on the valve stem;
(c) installing an actuating mechanism on the bonnet by a support, and connecting the screw to the valve stem by a connecting clamp block;
(d) conveying an assembled anti-static globe valve for hyperbaric oxygen to a connecting position of a pipeline, and hermetically connecting two air ports of the valve body to the pipeline;
(e) rotating the actuating mechanism in a forward direction to cause the actuating mechanism to drive the nut to rotate and the screw rod meshed with the nut to move linearly, thereby enabling the valve stem to drive the valve disc to move upwards along the inner wall of the upper sleeve, causing an end of the lower sleeve to be opened, such that the anti-static globe valve for hyperbaric oxygen is opened to enable a medium to flow along an air channel of the valve body;
(f) during opening of the anti-static globe valve for hyperbaric oxygen, enabling the medium from one space of the upper sleeve to reach another space of the upper sleeve through a balance hole to reduce a pressure difference between the two spaces, thus reducing an operation torque;
(g) rotating the actuating mechanism in a reverse direction to cause the valve stem to drive the valve disc to move downwards along the inner wall of the upper sleeve, causing the end of the lower sleeve to be gradually closed, such that the anti-static globe valve for hyperbaric oxygen is closed to cut off the flowing of the medium in the air channel of the valve body; and
(h) taking out the valve disc, the upper sleeve, the lower sleeve, the lip-shaped seal ring or the valve seat for replacement only by opening the bonnet when a component inside the anti-static globe valve for hyperbaric oxygen is damaged.

11. The anti-static globe valve for hyperbaric oxygen according to claim 10, further comprising a bonnet, wherein the valve stem passes through and is slidingly connected to the bonnet.

12. The anti-static globe valve for hyperbaric oxygen according to claim 11, wherein packing is filled between contact surfaces of the valve stem and the bonnet.

13. The anti-static globe valve for hyperbaric oxygen according to claim 11, further comprising an actuating mechanism and a support , wherein the actuating mechanism is erected on the bonnet by the support; the actuating mechanism comprises a screw, a nut, and an actuator; the screw is meshed with the nut, and the nut is installed in the support by a bearing, and the actuator is configured to drive the nut to rotate so as to cause the screw to move linearly.

14. The anti-static globe valve for hyperbaric oxygen according to claim 13, wherein the screw is connected to the valve stem by a connecting clamp block, the connecting clamp block is fixedly connected to the valve stem and is rotationally connected to the screw.

15. The anti-static globe valve for hyperbaric oxygen according to claim 14, wherein the valve stem and the valve disc are in threaded connection at conical contact surfaces, such that the valve stem and the valve disc are integrated as a whole.

16. The anti-static globe valve for hyperbaric oxygen according to claim 10, wherein a cross section of the valve disc is U-shaped and is able to divide the upper sleeve into two spaces; and the valve disc has a height greater than a diameter of the lower sleeve.

17. The anti-static globe valve for hyperbaric oxygen according to claim 16, wherein a lip-shaped seal ring is provided at the contact surfaces of the upper sleeve and the lower sleeve, and the lip-shaped seal ring is in contact with a sidewall of the valve disc.

18. The anti-static globe valve for hyperbaric oxygen according to claim 16, wherein the valve disc is at least provided with one balance hole, and the balance hole is configured to communicate the two spaces separated by the upper sleeve with each other.
